(19) United States
(12) Patent Application Publication
(10) Pub. No.: US 2026/0089196 A1
(43) Pub. Date: Mar. 26, 2026

(54) METHODS AND SYSTEMS FOR COMMUNICATION MANAGEMENT

(71) Applicant: Comcast Cable Communications, LLC, Philadelphia, PA (US)

(72) Inventors: Vengatarajulu Rajasekar, Mount Laurel, NJ (US); Eric Wong, Mount Laurel, NJ (US); Varatharajan Arulmurugan, Mount Laurel, NJ (US)

(21) Appl. No.: 18/895,803

(22) Filed: Sep. 25, 2024

(51) Int. Cl. H04L 65/1096; H04L 65/1069; H04L 65/1104; H04M 3/42

(52) U.S. Cl. CPC H04L 65/1096; H04L 65/1069; H04L 65/1104; H04M 3/42042

(57) ABSTRACT

Methods and systems for communication management are described. Supplemental data may be inserted into an outgoing call. It may be determined the recipient device is not configured to process the supplemental data. The supplemental data may be processed for output at the recipient device.

### BACKGROUND

A rise in spam calls has led to an increase in phone users ignoring calls from unknown numbers. This behavior is driven by a desire to reduce exposure to scams, annoyance, and wasted time. In the case of legitimate calls from unknown numbers there is a lack of capability for callers to provide additional information to the intended recipient, and thereby increase the chances the intended recipient will answer the call from the unknown number. Recipients ignoring legitimate calls solely because the recipient does not recognize the number leads to business losses, service interruptions, and other problems. Rich Call Data (RCD) may allow callers to provide additional information to intended recipients, but not all receiving user devices are configured to process RCD. If the recipient device is not configured to process the RCD, the additional information is not output on the recipient device and the intended recipient never receives the additional information.

### SUMMARY

It is to be understood that both the following general description and the following detailed description are exemplary and explanatory only and are not restrictive. Methods and systems for call management are described. It may be determined that a receiving user device is not configured to process RCD. If the receiving user device is not configured to process the RCD, the RCD may be routed to a device configured to decrypt the RCD and repackage the RCD according to another protocol and send the repackaged RCD to the user device.

### BRIEF DESCRIPTION OF THE DRAWINGS

The accompanying drawings, which are incorporated in and constitute a part of this specification, show examples and together with the description, serve to explain the principles:

FIGS. 1A-1B show an example system;

FIG. 2 shows an example system and method;

FIG. 3 shows an example system and method;

FIG. 4 shows an example system and method;

FIG. 5 shows example data and processing;

FIGS. 6A-6D show example user interfaces;

FIG. 7 shows an example method;

FIG. 8 shows an example system and method;

FIG. 9 shows an example method;

FIG. 10 shows an example method;

FIG. 11 shows an example method;

FIG. 12 shows an example method; and

FIG. 13 shows an example system for communication management.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. If such a range is expressed, another configuration includes from the one particular value and/or to the other particular value. Similarly, if values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal configuration. “Such as” is not used in a restrictive sense, but for explanatory purposes.

It is to be understood that if combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application reference is made block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

“Content items,” as the phrase is used herein, may also be referred to as “content,” “content data,” “content information,” “content asset,” “multimedia asset data file,” or simply “data” or “information. ” Content items may be any information or data that may be licensed to one or more individuals (or other entities, such as business or group). Content may be electronic representations of video, audio, text and/or graphics, which may be but is not limited to electronic representations of videos, movies, or other multimedia, which may be but is not limited to data files adhering to MPEG2, MPEG, MPEG4 UHD, HDR, 4k, Adobe® Flash® Video (.FLV) format or some other video file format whether such format is presently known or developed in the future. The content items described herein may be electronic representations of music, spoken words, or other audio, which may be but is not limited to data files adhering to the MPEG-1 Audio Layer 3 (.MP3) format, Adobe®, CableLabs 1.0, 1.1, 3.0, AVC, HEVC, H.264, Nielsen watermarks, V-chip data and Secondary Audio Programs (SAP). Sound Document (.ASND) format or some other format configured to store electronic audio whether such format is presently known or developed in the future. In some cases, content may be data files adhering to the following formats: Portable Document Format (.PDF), Electronic Publication (.EPUB) format created by the International Digital Publishing Forum (IDPF), JPEG (.JPG) format, Portable Network Graphics (.PNG) format, dynamic advertisement insertion data (.csv), Adobe® Photoshop® (.PSD) format or some other format for electronically storing text, graphics and/or other information whether such format is presently known or developed in the future. Content items may be any combination of the above-described formats.

This detailed description may refer to a given entity performing some action. It should be understood that this language may in some cases mean that a system (e.g., a computer) owned and/or controlled by the given entity is actually performing the action.

The present methods and systems provide an improvement in communications technologies and related technologies

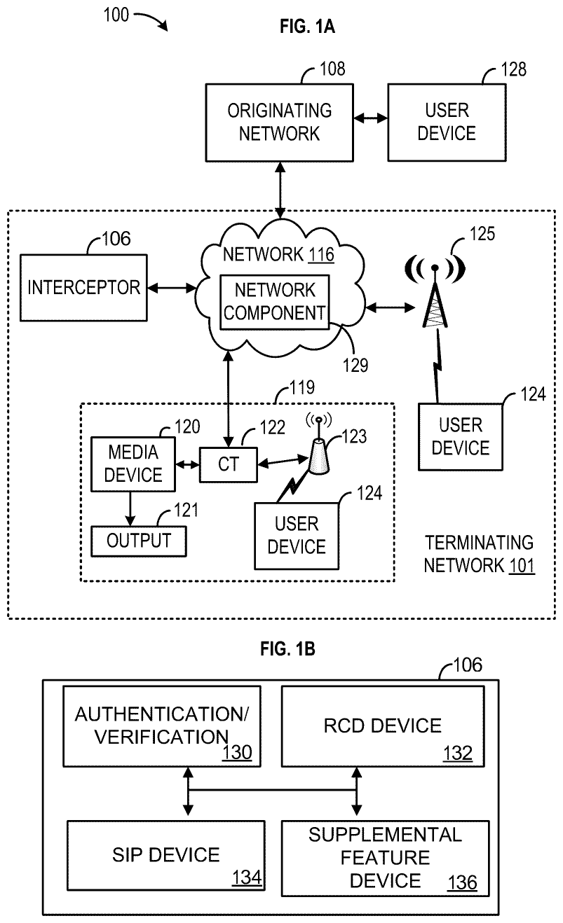

FIG. 1 shows a system 100 for communication management. Those skilled in the art will appreciate that digital equipment and/or analog equipment may be employed. Those skilled in the art will appreciate that provided herein is a functional description and that the respective functions may be performed by software, hardware, or a combination of software and hardware.

The system 100 may comprise a terminating network 101, an originating network 108, and one or more intermediary networks. Although network 116 is shown in the terminating network 101, the illustration is merely exemplary and explanatory and not limiting. For example, the network 116 may be an intermediary network (e.g., a transit network) between the terminating network 101 and the originating network 108. The system 100 may comprise a terminating user device 124 in the terminating network and an originating user device 128 associated with the originating network 108. The terminating network 101 may comprise an interceptor device 106, a media device 120, an output device 121, a communications terminal 122, a first access point 123, a second access point 125 (e.g., a headend, fiber optic, or satellite communications facility), various other devices, combinations thereof, and the like.

The network 116 may facilitate sending data to and from the various devices of the system 100. The network 116 may be a telecommunications network, a content delivery network, a content access network, combinations thereof, and the like. The network may be managed (e.g., deployed, serviced) by a content provider, a service provider, combinations thereof, and the like. The network 116 may be a plain-old telephony (POTS) network, a wireless cellular network, an optical fiber network, a coaxial cable network, a hybrid fiber-coaxial network, a wireless network, a satellite system, a direct broadcast system, or any combination thereof. The network 116 can be the Internet. The network 116 may have a network component 129. The network component 129 may be any device, module, combinations thereof, and the like communicatively coupled to the network 116. The network component 129 may be a router, a switch, a splitter, a packager, a gateway, an encoder, a storage device, a multiplexer, a network access location (e.g., tap), physical link, combinations thereof, and the like.

The user device 124 may comprise one or more of a cell phone, a smart phone, a laptop computer, a desktop computer, a tablet, a virtual assistant device, a plain old telephone (POTS), combinations thereof and the like.

The user device 124 may be configured to receive an incoming call and/or to place an outgoing call. The term “incoming call” refers to a point of view of the device and/or network receiving the call (e.g., the terminating device or the terminating network). The term “outgoing call” may refer to the same call, but from the point of view of the device placing the call and/or the network associated with the device placing the call. For example, a call may be placed by the user device 128 (e.g., the originating device) and directed towards the user device 124 (e.g., the terminating device). Thus, from the point of view of the user device 128, the call is an outgoing call, but from the point of view of the user device 124, the call is an incoming call.

The call may be sent by a user device (e.g., a user associated with the user device may dial a number). The outgoing call may be sent via one or more first protocols. For example, the one or more first protocols may comprise one or more of: Plain Old Telephony Service (POTS), WebRTC, HTTP/HTTPS, email or other messaging service, push notifications, one or more data fetches, and/or an SIP protocol message. For example, the call may be placed automatically in response to a wake word or other similar trigger. The call may be bound for a recipient device (e.g., the user device 124). The recipient device may be associated with the recipient network (e.g., the terminating network 101). The call may comprise one or more of: a session initiation protocol (SIP) invite, a plain old telephony service (POTS) call, voice over internet protocol (VOIP) call, video call, cellular call, voice over LTE call, Wi-Fi call, application message, push-to-talk (PTT) call, or emergency network call.

The call may comprise supplemental data. The supplemental data may comprise rich call data (RCD). The rich call data may be encoded into the outgoing call. The rich call data may be inserted into the outgoing call and configured to be output on the recipient device. The rich call data may be inserted into the outgoing call before the outgoing call leaves an originating network before entering the recipient network. Similarly, the rich call data may be inserted at the terminating network. For example, the rich call data may comprise caller identifier information such as a name, contact information, phone numbers, addresses, combinations thereof, and the like. For example, the rich call data may comprise the responses to the one or more outputs (e.g., the user inputs received in response to the one or more prompts) so as to convey additional information to the recipient of the call. The rich call data may comprise image data (e.g., a logo), text data (e.g., a message configured to be displayed via the recipient device), audio data, one or more resource identifiers (e.g., one or more URLs, or the like), combinations thereof, and the like.

The supplemental data may comprise caller ID data, call parameter data, session description data, media negotiation data, network address data, call routing data, presence data, service-specific data, and/or error and status data. For example, in a VoIP invite or call initiation message, various supplemental data elements may be included to manage and facilitate the communication session. For example, the caller ID data may comprise essential information about the caller, such as their name, phone number, or username. For example, the call parameters may be conveyed to specify settings like call type (voice, video, conference), priority, supported codecs, and preferred media formats. For example, the session description may be provided, delineating session characteristics such as duration, start and end times, and any associated scheduling details. For example, media negotiation information is exchanged to determine compatible codecs, media formats, and bandwidth constraints between parties. For example, the network addressing information, including IP addresses and ports, may be shared to establish the connection between the calling and called parties. For example, the authentication and security details, encompassing mechanisms, encryption algorithms, and protocols used to secure the session, may be communicated. For example, the call routing information is may be communicated to indicate the path and network elements involved in connecting the parties, including gateways or proxies. For example, the presence information may convey the availability status of the caller, indicating whether they are reachable at the moment. Additionally, service-specific data such as call history, recording preferences, or customized features may be included. Further, error and status codes may be transmitted to communicate the outcome of the call initiation process, indicating success, failure, or encountered errors.

The interceptor device 106 may detect the incoming call. The interceptor device 106 may comprise a switch, and RCD processing component, and various other components. The switch may comprise various components within a cellular network infrastructure, facilitating the routing of calls, data, and other communication signals between different network components. For example, among these components may be the Mobile Switching Center (MSC), responsible for managing call setup, routing, termination, and mobility management between mobile devices and external networks such as the Public Switched Telephone Network (PSTN). The switch may comprise a Base Station Controller (BSC) configured to oversee multiple Base Transceiver Stations (BTS) and manage radio resources and handovers. In modern networks like 4G LTE and 5G, packet switches are essential for handling data traffic, ensuring the smooth transmission of data packets between various network elements. These switches collectively manage voice and data traffic, optimize network resources, and uphold reliable connectivity for users across the cellular network.

The interceptor device 106 may determine the call comprises supplemental data (e.g., rich call data). For example, the interceptor device 106 may comprise an authentication/verification device 130. The authentication/verification may be implemented as a STIR/SHAKEN protocol. The authentication/verification device 130 may be configured to implement the Secure Telephone Identity Revisited (STIR) and Signature-based Handling of Asserted Information Using toKENs (SHAKEN) framework, which authenticate and verify caller identities. This process involves digitally signing caller information and transmitting it across the network to ensure its integrity and authenticity. For example, when a call is initiated, an originating service provider (e.g., OSP associated with the originating user device 128 and/or originating network 108) receives a call setup request and uses a STIR/SHAKEN authentication service to generate a digital certificate. The digital certificate contains information about the calling party's number and the OSP's identity, which is then signed using a private key to create a digital signature.

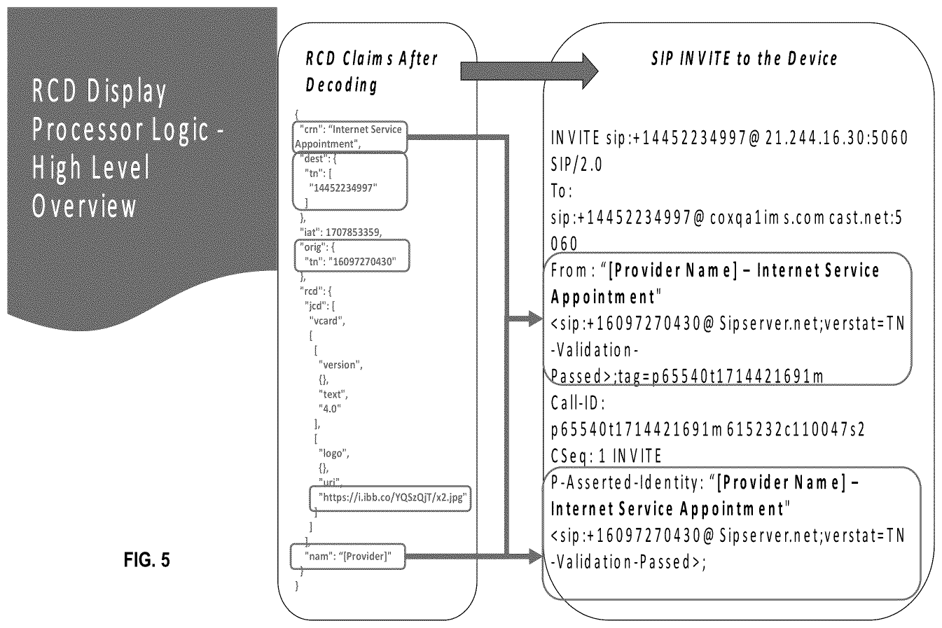

The authentication/verification device 130 may determine if the incoming call contains RCD. For example, an identity header may comprise RCD (e.g., one or more RCD claims, as described in greater detail with respect to FIG. 5). For example, the authentication/verification device 130 may decode the identity header, which may contain RCD. If so, the authentication/verification device 130 may determine to send the call and the RCD to the RCD device. For example, the authentication/verification device 130 may send the RCD to the RCD device to be repackaged into display name data.

The interceptor device 106 (e.g., via the RCD device 132) may determine a user device identifier associated with the recipient device (e.g., an identifier associated with the user device 124). For example, the RCD device 132 may determine, for example, based on the user device identifier associated with the recipient device, that the recipient device is not configured to process the supplemental data. For example, the RCD device 132 may comprise an internal look-up table. The internal look-up table may comprise one or more device identifiers and one or more device attributes associated with one or more recipient devices associated with the terminating network. For example, the internal look-up table may comprise (e.g., may indicate) one or more display attributes associated with the one or more recipient device associated with the terminating network. The internal look-up table, and display attributes stored therein, facilitate the repackaging of the RCD to another protocol (e.g., an SIP invite) configured to be output on the recipient device that is not configured to process the RCD.

The determination as to whether or not any given recipient device is configured to process RCD may be based on a device identifier associated with the recipient device, a device model indicator associated with the recipient device, one or more display attributes associate with the recipient device (e.g., a number of characters which the recipient device display can output, including with or without scrolling characters, and/or a year of manufacture associated with the recipient device). For example, the display attribute associated with the recipient device indicates limited display capabilities, the RCD device 132 may repackage the RCD. For example, if the year of manufacture is earlier than a predetermined year, the RCD device 132 may determine the recipient device is not configured to process the RCD.

For example, the interceptor device 106 may determine the recipient device is not configured with rich communication service (RCS) capabilities. RCS capabilities are needed to process RCD. RCS components (e.g., services resident on an application on the recipient device) are configured to receive RCD packets, decode the RCD packets, and extract text, multimedia content, and other data from the RCD packets. However, if the recipient device does not have these RCS capabilities, the recipient device is unable to process the RCD, and thus the intended recipient user never receives the supplemental data (e.g., caller name, call reason, caller logo, etc. . . . )

Based on determining the recipient device is not configured to process the supplemental data, the interceptor device 106 may take one or more actions. For example, based on determining the recipient device is not configured to process the supplemental data, the interceptor device 106 may cause the supplemental data (e.g., RCD) to be repackaged. For example, the interceptor device 106 may cause the supplemental device data to be repackaged into an SIP protocol data format. For example, the RCD component 132 (shown in FIG. 1B), may be configured to process RCD. For example, based on determining the recipient device is not configured to process the RCD, the RCD component 132 may repackage the RCD to a different protocol (e.g., an SIP protocol). Thereby, the information included in the RCD packets, despite the absence of RCS capabilities on the recipient device, can still be output on the recipient device by virtue of having been repackaged to a different protocol (e.g., an SIP protocol).

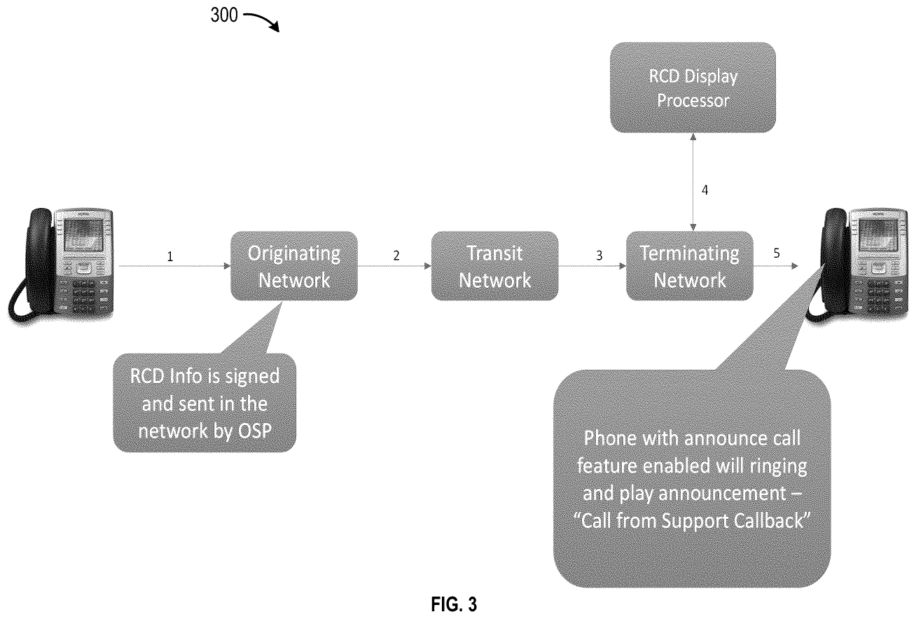

The interceptor device 106 may forward the call and/or any information associated with the call to a pre-call announcement server (as discussed in greater detail in FIG. 3). The call and/or information associated with the call may be sent to a call log server (as discussed in greater detail in FIG. 3). The interceptor device 106 may decode the STIR/SHAKEN data to determine the supplemental data. The supplemental data may comprise one or more claims (e.g., support callback, name, company). The interceptor device 106 may determine one or more RCD headers, and thereby determine the presence of RCD.

The interceptor device 106 may establish a pre-call session (e.g., an early media session) with the terminating device. The interceptor device 106 may establish the pre-call session with the terminating device based on determining the terminating device is not configured to process the RCD. For example, the interceptor device 106, based on determining the recipient device is not configured to process rich call data, may cause the recipient device to output text data.

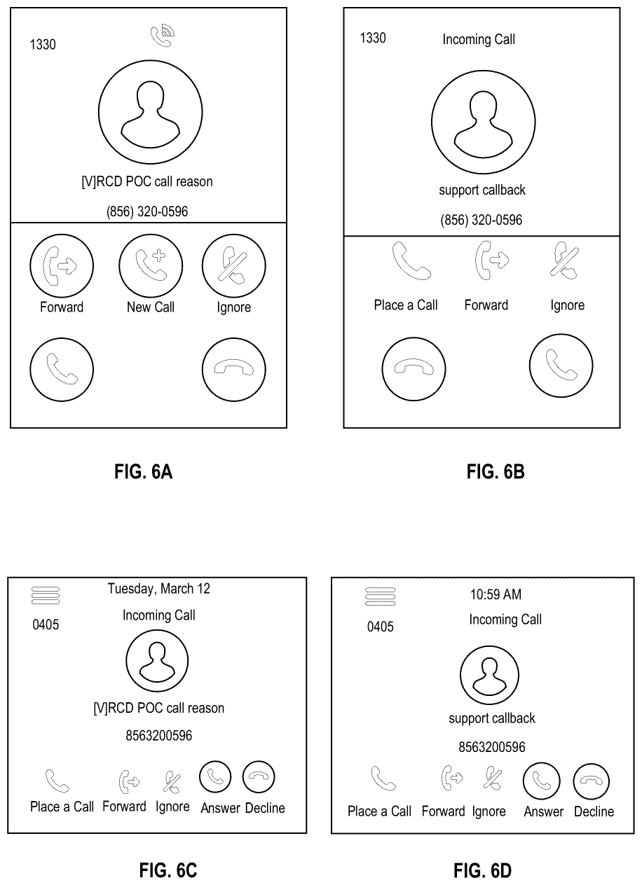

The text data may be output based on the one or more display attributes associated with the recipient device. For example, the RCD device 132 may determine display capabilities associated with the recipient device as described below with respect to FIG. 1B. The text data output may comprise the one or more RCD claims in the call initiation message that have been repackaged. For example, as described below with respect to FIG. 5 and FIG. 6, the one or more RCD claims (e.g., caller identity, reason for call) may be repackaged into a protocol compatible with the recipient device as, for example, one or more display names.

The interceptor device 106 may determine one or more call types associated with the outgoing call. The one or more call types may comprise, for example, a legitimate call type and/or a spam call type. For example, the intercept device may determine the one or more call types based on one or more identifiers associated with the device placing the outgoing call, one or more identifiers associated with a user of the device placing the outgoing call, one or more numbers (e.g., phone numbers) associated with the device placing the outgoing call, one or more identifiers associated with the device receiving the outgoing call, one or more identifiers associated with a user of the device receiving the outgoing call, one or more numbers (e.g., phone numbers) associated with the device receiving the outgoing call, combinations thereof, or the like. For example, the interceptor device 106 may determine the outgoing call is from a user device associated with a number on an authorized list and may intercept the call to facilitate the collection of data to insert into the call as Rich Call Data. For example, the intercept device 106 may determine the outgoing call is a spam call type based on the one or more identifiers. Based on determining the outgoing call is a spam call, the interceptor device 106 may not intercept the spam call. Based on determining the outgoing call is a spam call, the interceptor device 106 may insert one or more preconfigure rich call data into the spam call (e.g., a notification the call may be spam).

Returning to the components of system 100, the media device 120 may be configured to receive content and other associated data (e.g., metadata). The media device 120 may comprise a user device such as a set-top-box (STB), computer, mobile phone, combinations thereof, and the like. The media device 120 may be a digital streaming device, a gaming device, a media storage device, a digital recording device, a computing device, a mobile computing device (e.g., a laptop, a smartphone, a tablet, etc.), combinations thereof, and the like.

The media device 120 may comprise a demodulator, decoder, frequency tuner, combinations thereof, and the like. The media device 120 may be directly connected to the network (e.g., for communications via in-band and/or out-of-band signals of a content delivery network) and/or connected to the network 116 via a communication terminal 122 (e.g., for communications via a packet switched network). The media device 120 may implement one or more applications, such as content viewers, social media applications, news applications, gaming applications, content stores, electronic program guides, combinations thereof, and the like. Those skilled in the art will appreciate that the signal may be demodulated and/or decoded in a variety of equipment, including the communication terminal 122, a computer, a TV, a monitor, or a satellite dish. The communication terminal 122 may be located at the user location 119. The communication terminal 122 may be configured to communicate with the network 116. The communication terminal 122 may be a modem (e.g., cable modem), a router, a gateway, a switch, a network terminal (e.g., optical network unit), combinations thereof, and the like. The communication terminal 122 may be configured for communication with the network 116 via a variety of protocols, such as IP, transmission control protocol, file transfer protocol, session initiation protocol, voice over IP (e.g., VoIP), combinations thereof, and the like. The communication terminal 122, for a cable network, may be configured to facilitate network access via a variety of communication protocols and standards, such as Data Over Cable Service Interface Specification (DOCSIS).

A first access point 123 (e.g., a wireless access point) may be located at the user location 119. The first access point 123 may be configured to provide one or more wireless networks in at least a portion of the user location 119. The first access point 123 may be configured to facilitate access to the network 116 to devices configured with a compatible wireless radio, such as a mobile device 124, the media device 120, the display device 121, or other computing devices (e.g., laptops, sensor devices, security devices). The first access point 123 may be associated with a user managed network (e.g., local area network), a service provider managed network (e.g., public network for users of the service provider), combinations thereof, and the like. It should be noted that in some configurations, some or all of the first access point 123, the communication terminal 122, the media device 120, and the display device 121 may be implemented as a single device.

The user location 119 is not necessarily fixed. A user may receive content from the network 116 on the mobile device 124. The mobile device 124 may be a laptop computer, a tablet device, a computer station, a personal data assistant (PDA), a smart device (e.g., smart phone, smart apparel, smart watch, smart glasses), GPS, a vehicle entertainment system, a portable media player, a combination thereof, combinations thereof, and the like. The mobile device 124 may communicate with a variety of access points (e.g., at different times and locations or simultaneously if within range of multiple access points), such as the first access point 123 or the second access point 125.

FIG. 1B shows an example diagram of one or more components of the interceptor device 106. The interceptor device 106 may comprise an authentication/verification device 130. The authentication/verification device 130 may be configured to decode one or more identity headers, one or more display names, SIP invite information, or other information as described herein in a call initiation message (e.g., call invite) sent from the sending user device. For example, if the interceptor device 106 is in the terminating network, the authentication/verification device 130 may decode one or more identity headers and validate one or more signatures to determine a valid (passed/failed) or no-validation status. For example, based on the verification results, the authentication/verification device 130 modify the SIP invite with additional parameters. For example, the authentication/verification device 130 may insert verstat in the FROM field and one or more PAI (P-Asserted Identity) headers on the SIP invite and add a “[v]” to the CNAM (display name) in the FROM and PAI headers. For example, the decoded RCD data may be inserted into the display name (CNAM) based on the capability of the recipient device.

The interceptor device 106 may comprise an RCD display processor 132. The RCD display device 132 may be configured to determine one or more display parameters associated with a receiving user device. For example, the RCD display processor 132 may be configured to determine a number of characters capable of being displayed by the receiving user device. For example, the RCD display processor 132 may be configured determine, based on one or more user device identifiers associated with the recipient user device, that the recipient user device is an older device capable of only displaying up to 15 characters. Similarly, the RCD display processor 132 may be configured to determine, for example, based on one or more user device identifiers associated with the recipient user device, that the recipient user device is a new device (e.g., an IP enabled telephone) and is capable of displaying 34 or 44 characters. For example, the display capabilities of the recipient user device may be retrieved from a subscriber database (not shown). The RCD display processor 132 may be configured to determine display data to be displayed at (e.g., output via) the recipient user device. For example, the RCD display processor may determine the display data based on the display capabilities of the recipient user device. For example, if the recipient user device is only capable of displaying 15 characters, the RCD display processor 132 may send 15 characters to the recipient user device. For example, if the recipient user device is capable of displaying 34-44 characters, the RCD display processor 132 may cause 34-44 characters to be sent to the recipient user device. Further, if the recipient user device is has a scroll capability (which may also be retrieved from/determined by the subscriber database), the RCD display processor may cause more characters than can be displayed by the recipient user device to be sent to the recipient user device, and may cause the recipient user device to scroll so as to display additional characters (e.g., beyond the 15 or 34-44 characters).

The interceptor device 106 may comprise an SIP module 134. The SIP module may be configured to process, decode, add, remove, edit, store, or otherwise process data to be included or excluded from an SIP invite according to RFC protocols. For example, the SIP module 134 may be configured to populate one or more SIP invite data fields with the text generated based on the user responses to the one or more prompts. A standard SIP (Session Initiation Protocol) handshake may comprise a series of messages exchanged between the initiating device (e.g., the originating device) and the target device (e.g., the recipient device). This exchange is orchestrated to establish, modify, or terminate a communication session. Initially, the originating device may be configured to send an INVITE request to the recipient device, expressing its intent to commence a session. This request contains pertinent information, such as the SIP address of the intended recipient and the type of session desired, whether it may be a voice call, video call, or another form of communication. Upon receipt of the INVITE request, a server may process it and respond with a provisional response (1xx), signifying acknowledgment and indicating that it is actively processing the request. This provisional response may include additional information or headers. Subsequently, the server may further respond with a final response (2xx) once the session has been successfully established. This response may comprise essential details such as the session description (SDP-Session Description Protocol), which may include specifics about the media types, codecs, and network addresses to be employed for the communication session. After the successful establishment of the session, the client may send an ACK (acknowledgment) message to the server, confirming the session setup. Additionally, throughout the duration of the session, either party may need to modify certain parameters, such as adding participants or altering media characteristics. To facilitate this, the party initiating the modification may be configured to send a new INVITE request with the updated parameters, and the other party may respond accordingly. Finally, when the session needs to be terminated, either party may send a BYE request, indicating the desire to end the session. Upon receipt of the BYE request, the recipient sends a final response, and the session may be terminated. Throughout this process, both the client and the server may exchange various SIP messages such as OPTIONS, REGISTER, and NOTIFY, which help manage and facilitate the communication session according to SIP protocol standards.

The interceptor device 106 may comprise a supplemental feature module 136. The supplemental feature module 136 may be configured to determine, generate, receive, send, or otherwise process or provide one or more supplemental features. The one or more supplemental features may comprise, for example, one or more images (e.g., one or more logos, one or more pictures, etc), one or more hyperlinks, one or more applications or applets, one or more gifs, one or more advertisements, one or more emojis, one or more short videos, combinations thereof and the like. The supplemental feature module 136 may be configured to activate or output, on the recipient device, the one or more supplemental features. For example, based on the text generated from the user inputs and/or RCD, the supplemental feature module may determine a logo associated with the company in the response, and cause output of the logo of the company at the recipient device or if the recipient device is not configured to process the logo, may convert text to speech and output the audio associated with the speech.

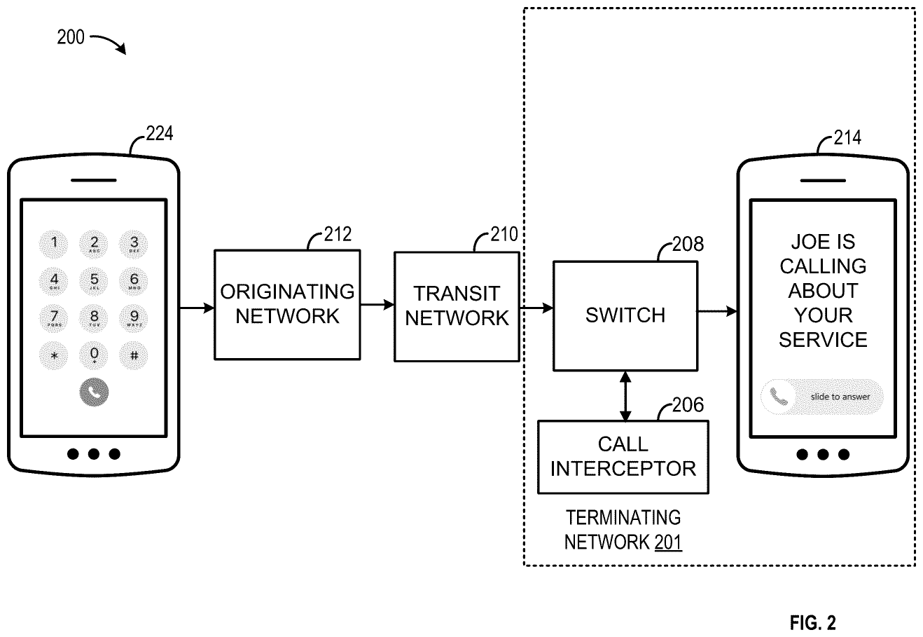

FIG. 2 shows an example system 200. The system 200 may comprise a terminating network 201, an originating user device 224 (e.g., the mobile device 128), a switch 208, a call interceptor 206, a transit network 210, an originating network 212, and a recipient device 214. The user device 214, the switch 208, and the call interceptor 206 may in the terminating network 201. A call may be placed by user device 224. The call may be intended for user device 214. The call may traverse the originating network 212, (optionally) a transit network 210, and be received in the terminating network by switch 208.

The outgoing call may be detected by the switch 208. The switch 208 a switch may be a device within a telephone exchange, such as the public switched telephone network (PSTN), configured to connect calls from the requester to the destination. The switch 208 may be configured to detect a placed call, detect an “off-hook” condition associated with either or both of the user device 224 and/or the user device 214, detect and/or initiate a pre-call session (e.g., an early media session), similar conditions and/or one or more signals related thereto. The outgoing call may comprise one or more of: a session initiation protocol (SIP) invite, a plain old telephony service (POTS) call, voice over internet protocol (VOIP) call, video call, cellular call, voice over LTE call, Wi-Fi call, application message, push-to-talk (PTT) call, or emergency network call.

The switch may route the call to the interceptor. The interceptor may route the call to one or more other devices (e.g., as discussed in greater detail in herein). For example, the interceptor may route the call to an authentication/verification device (e.g., a STIR/SHAKEN server (not shown)), a call-log server (not shown), a pre-call announcement server (not shown), or any other device. A communication session may be established between the intercept device and either or both of the user device 224 and/or the user device 214. The communication session between the intercept device and the user device(s) may be established based on the intermediary device detecting the call.

FIG. 3 shows an example system and method 300. An originating device (on the left) may send a call invite (at 1). The call invite may be received and processed be one or more devices in the originating network as described herein. For example, an authentication/verification device (e.g., a STIR/SHAKEN server (not shown in FIG. 3, but described in greater detail herein)) may receive the call invite (e.g., from a switch device in the originating network), process the call invite, sign the RCD information, and send the call back to the switch for forwarding out to the transit network. At 2, the transit network may receive the call and forward to a terminating network (at 3). In the terminating network, the call may be send the call to one or more devices in the terminating network (e.g., a switch device, a STIR/SHAKEN server, an RCD display processor) to process the call (at 4). At 5, after processing as described herein, the call may be sent to a recipient user device in the terminating network. For example, if the recipient device may be configured with a pre-call announcement capability. For example, the recipient user device may be configured to output a pre-call announcement (e.g., “Call from Support Callback”). Similarly, if the recipient user device has display capabilities as described herein, the recipient user device may display information about the call (e.g., text data such as caller information such as caller ID, reason for call and/or image data such as one or more logos or advertisements).

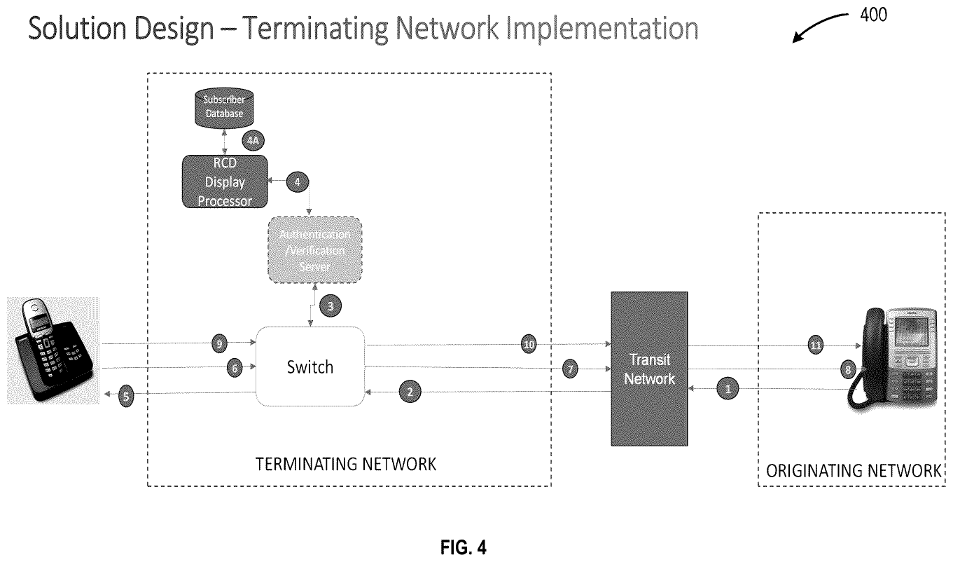

FIG. 4 shows a flowchart of an example method 400. At step 1, a communication request may be placed. The communication request may comprise a call invite. The communication request may comprise supplemental data. For example, the communication request may comprise rich call data, image data, audio data, resource data, combinations thereof, and the like. The communication request may comprise one or more identifiers associated with the originating device (e.g., the device in the originating network) and one or more identifiers associated with the device in the terminating network. For example, the communication request may comprise an RCD identity. At step 2, the communication request may transit the transit network and be received by a switch. The communication request may comprise the RCD identity. At step 3, the switch may forward the call comprising RCD to an authentication/verification server. The authentication/verification server may comprise a STIR/SHAKEN server. The authentication/verification server may determine the RCD, decode the call (e.g., decode the identity header, decode other data in the call), and determine whether the recipient device is configured to process RCD. The authentication/verification server may be configured to decode one or more identity headers, one or more display names, SIP invite information, or other information as described herein in a call initiation message (e.g., call invite) sent from the sending user device.

At 4, based on determining the call comprises RCD and the recipient device is not configured to process the RCD, the authentication/verification server may send the call and/or any associated information to an RCD device (e.g., an RCD Display processor). The RCD device may be configured to determine one or more display parameters associated with a receiving user device. For example, the RCD device may be configured to determine a number of characters capable of being displayed by the receiving user device. For example, based on the receiving user device device model and number of characters the receiving user device supports (e.g., as determined based on querying a subscriber database), it may be determined how to send the RCD data. For example, sending the RCD data may conform to a standard RCD specification and/or the RCD data may be converted according to an existing calling name representation (CNAM) format or protocol.

For example, the RCD device may be configured determine, based on one or more user device identifiers associated with the recipient user device, that the recipient user device is an older device capable of only displaying up to 15 characters. Similarly, the RCD display processor may be configured to determine, for example, based on one or more user device identifiers associated with the recipient user device, that the recipient user device is a new device (e.g., an IP enabled telephone) and is capable of displaying 34 or 44 characters. For example, the display capabilities of the recipient user device may be retrieved from a subscriber database (not shown). The RCD display processor may be configured to determine display data to be displayed at (e.g., output via) the recipient user device. For example, the RCD display processor may determine the display data based on the display capabilities of the recipient user device. For example, if the recipient user device is only capable of displaying 15 characters, the RCD display processor may cause 15 characters to be sent to the recipient user device. For example, if the recipient user device is capable of displaying 34-44 characters, the RCD display processor may cause 34-44 characters to be sent to the recipient user device. Further, if the recipient user device is has a scroll capability (which may also be retrieved from/determined by the subscriber database at 4A), the RCD display processor may cause more characters than can be displayed by the recipient user device to be sent to the recipient user device, and may cause the recipient user device to scroll so as to display additional characters (e.g., beyond the 15 or 34-44 characters).

The RCD device may repackage the one or more headers (e.g., the one or more identity headers, call reason, or other RCD) into a display name field (e.g., as described in greater detail below with respect to FIG. 5) configured for output on the recipient device. The RCD device may repackage (e.g., reconfigure) the RCD according to the display attributes associated with the recipient device. For example, the RCD device may retrieve verified RCD claims and replace an existing CNAM field with the RCD.

Text data may be output on the recipient device to indicate the presence of RCD (even if the device is not configured to output the RCD itself). For example, based on the one or more identifiers associated with the receiving device, it may be determined whether a user associated with the receiving device has opted-in to one or more services (e.g., call authentication/verification based on RCD). For example, if it is determined the customer has opted-in, one or more indications may be output based on the RCD. For example, a [VR] (for verified and RCD present or only [V] for verified, but no RCD present.) or some other indication may be output.

At step 5, the invite that has been updated with RCD info in the display name and/or caller ID field may be sent to the recipient user device. For example, based on the CPE device model and number of characters supported by the recipient user device, it can be determined how to send the RCD data. For example, the system may be configured to follow standard RCD specification or convert the data into an existing CNAM format or protocol. The recipient user device may be configured to output the RCD information and/or play an announcement based on the RCD information.

At step 6, ringing may be initiated (e.g., the recipient user device may send a ringing signal towards the switch for forwarding to the sending user device to indicate the call has been placed and is awaiting answering) and at step 7, the ringing signal may be sent by the switch device to the transit network. The ringing may be distinctive to indicate the presence of RCD (e.g., a special tone may be played when RCD is present). The switch may send the ringing via the transit network to the originating user device (at step 8). At step 9, an OK signal may be sent to the switch. The OK signal may indicate the call has been “answered” but a communication session between the recipient device and the originating device is not yet established. Based on receiving the OK signal, the switch, at step 10, may send the OK signal out to the transit network where it will be forwarded to the originating user device at 11.

FIG. 5 shows RCD display processor logic. FIG. 5 shows one or more RCD claims (after being decoded). The present systems and methods may be configured to decode the RCD and determine one or more claims (shown in boxes on the left). The RCD may be received by the switch in a SIP invite or any other appropriate communication protocol (e.g., H.323, Web Real-Time Communication (WebRTC), Media Gateway Control Protocol (MGCP), Real-Time Transport Protocol (RTP), RTP Control Protocol (RTCP), Inter-Asterisk eXchange (IAX)).

For example, the crn (call reason claim) shows the call is for an “internet service appointment.” Similarly, the “dest” (destination) claim indicates the intended destination for the call. Similarly, the “uri” claim may indicate one or more paths to one or more media files (e.g., one or more logos, GIFs, images, etc. . . . ) Similarly, the “nam” (“name”) claim indicates a name for the caller. The authentication/verification device (e.g., a STIR/SHAKEN server) and RCD display device may be configured to work in combination to decode the RCD and convert the RCD to SIP invite data fields (as shown on the right).

The RCD claims may be repackaged. For example, the above identified fields (e.g., call reason, caller ID, destination, name, one or more logos etc. . . . may be repackaged into one or more fields in an SIP incite. For example, the decoded RCD claims may be repackaged into a display name field in the SIP invite. The SIP invite data fields may then be displayed (e.g., output via) the recipient user device.

Artificial intelligence and/or machine learning may be used in determining, based on the display capabilities associated with the recipient device, which information from the RCD claims is to be included in (e.g., repackaged into one or more data fields such as the display name) in the SIP invite. For example, artificial intelligence and/or machine learning methods may be used to prioritize the information in the RCD claims based on the display capabilities of the recipient device. For example, if the recipient device is configured to only display 15 characters, a machine learning model may learn which information is most important to include in the 15 characters. Further, language models may be implemented to scan for vulgarity, obscenity, and other undesirable language or images. The language model may also translate one or more first languages to one or more second languages.

FIGS. 6A-6D show example user interfaces associated with a recipient user device. As shown in FIGS. 6A-6D, the example user interfaces associated with the recipient user device may be configured to output data (e.g., text data, image data, audio data (not shown), combinations thereof, and the like). FIGS. 6A-6B show example user interfaces that may be found, for example, on a Poly CCX-500 IP Phone or other similar devices. For example, FIG. 6A shows “[V]RCD call reason.” This text data may be determined (e.g., by the authentication/verification server) and caused to be output accordingly (e.g., by RCD display processor) based on the RCD data in the call initiation message (e.g., the call invite). In the case of FIG. 6A, the “[V]” may indicate the call, call reason, or other aspects of the call are “verified” (e.g., likely not spam). On the other hand, as shown in FIG. 6B, the call reason (“support callback”) may be determined and displayed based on the RCD data, but the call might not be verified (as indicated by the lack of “[V]” indicator). FIGS. 6C-6D show example user interfaces that may be found on a Poly CCX-600 IP Phone or similar devices. FIGS. 6C-6D show similar information being output on the recipient user device based on the RCD data in the call invite.

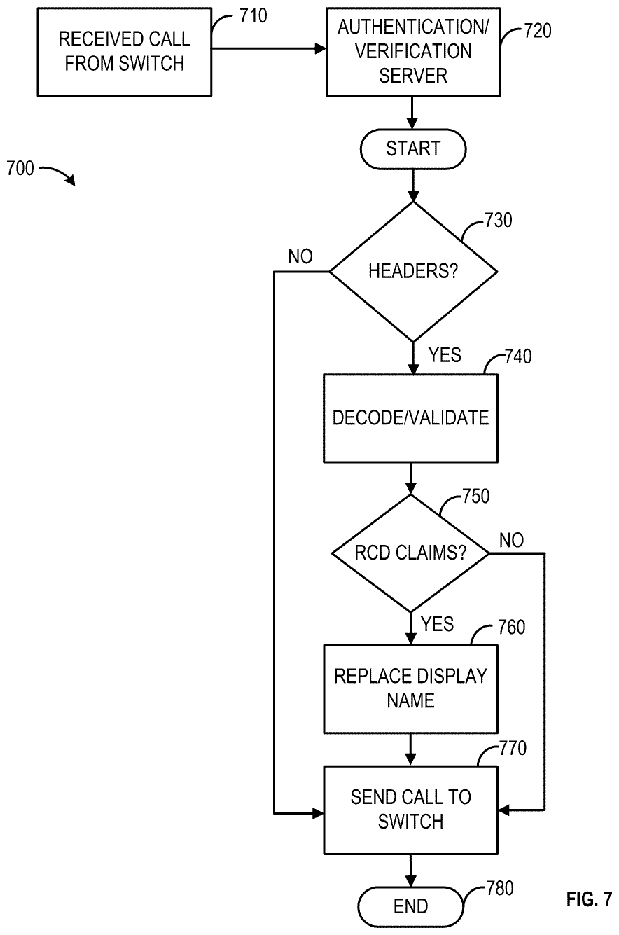

FIG. 7 shows a flowchart of a method 700. The method 700 may be carried out on any one or more of the devices described herein. The exemplary method in FIG. 7 shows authentication/verification server logic for a terminating network implementation of the systems and methods described herein. The authentication/verification logic may be carried out via a STIR/SHAKEN protocol For example, at 710, a call may be received at the terminating network. The call may originate from an originating user device. For example, the call may be received by a switch device associated with the terminating network. The switch device may determine the call contains RCD data. The switch device may route the call to the authentication/verification server. At 720, the authentication/verification server may receive the call. At 730, the authentication/verification server may determine whether the call invite contains STIR/SHAKEN headers. If the call invite includes STIR/SHAKEN headers, at 740, the STIR/SHAKEN headers may be decoded. Optionally, the STIR/SHAKEN headers may be validated/verified to determine a validated/verified status of the call. At 750, it may be determined whether or not the call invite contains RCD claims (as described previously with respect to FIG. 5). If the call contains RCD claims, at 760, the RCD claims may be repackaged. For example, the display name may be replaced with RCD information and a verification indicator (e.g., “[V]” or “[VR]”) may be inserted. At 770, the call may be sent back to the switch device with the repackaged RCD for forwarding towards the recipient user device. At 780, the process may end.

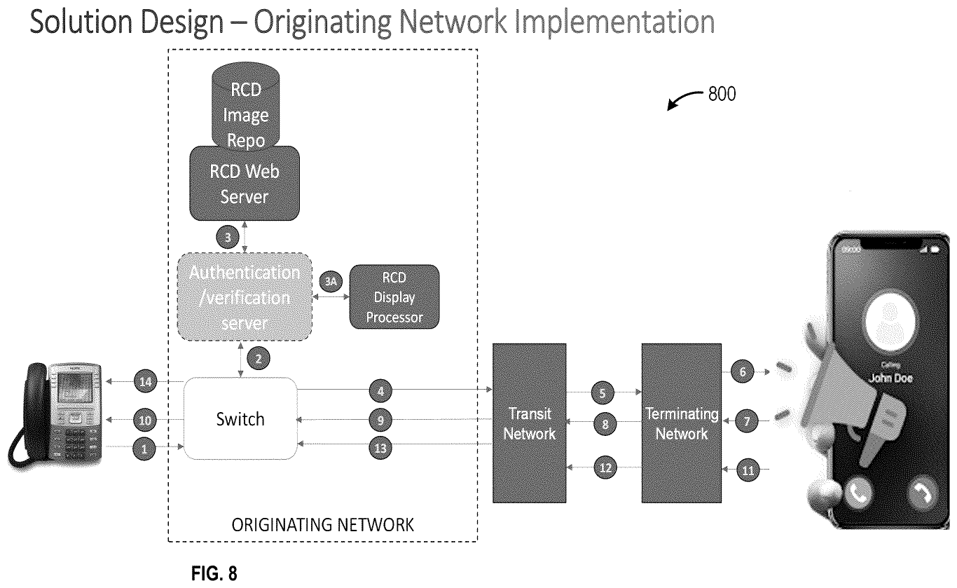

FIG. 8 shows an example system and method 800. The example system and method 800 may be carried out via any one or more devices described herein. The example system and method 800 shows an originating network implementation of the systems and methods described herein. For example, at 1, a communication request may be sent from a device in the originating network. The communication request may comprise supplemental data (e.g., RCD data). The communication request may comprise one or more identifiers associated with the originating device, one or more identifiers associated with the intended recipient device, one or more invite identifiers, and one or more call identifiers. The communication request may be sent to the switch. At 2, the switch device may send the communication request to an authentication/verification server (e.g., a STIR/SHAKEN server). The authentication/verification server may parse RCD data. The authentication/verification server may, at 3, send any one or more of the identifiers to an RCD web server which may comprise an RCD image repository. For example, the authentication/verification server may communicate with an RCD web server via one or more http rest APIs.

The RCD web server may associate any of the one or more identifiers in the communication request with one or more resource identifiers. At 3A, the RCD data may be sent to an RCD display processor for processing. The RCD display processor may process the RCD data and convert/repackage the RCD data to another protocol (e.g., SIP protocol) and/or repackage to displayable data (e.g., text data, image data) and send that data back to the authentication/verification server. At 4, the communication request (e.g., call invite) with RCD identifiers (and optionally/additionally updated CNAM) with RCD information may be sent out to a transit network and then to the terminating network (at 5), and ultimately to the recipient user device (at 6). The receiving device, if configured to, may parse the repackaged RCD and output (e.g., either via a display or audio interface) the repackaged RCD. At 7, the recipient device may send a ringing indication back to the terminating network, for forwarding to the transit network (at 8). The transit network may send the ringing indication to the switch in the originating network (at 9) and ultimately the ringing indication may be forwarded to the originating user device at 10. At 11, if the call is accepted/answered, the recipient user device may send an OK indication out to the terminating network which is forwarded by the terminating network to the transit network (at 12). The transit network may send the OK indication to the switch in the originating network (at 13), and the switch may send the OK indication to the originating user device at 14.

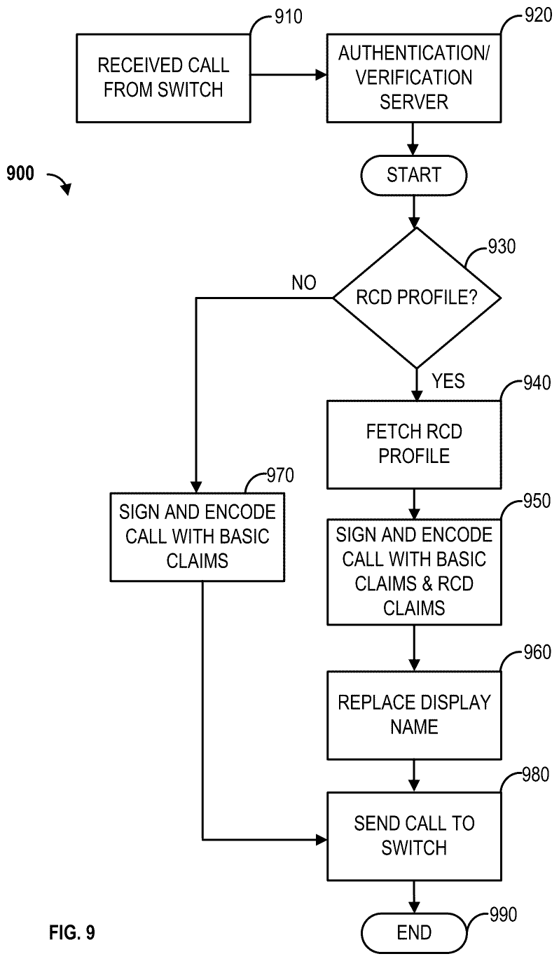

FIG. 9 shows an example method 900. The example method 900 may be carried out by any one or more devices described herein. The example method 900 shows an originating network implementation of the systems and methods described herein. At 910, a call may be received by a switch device in the originating network. The call may originate from (e.g., be sent by) an originating user device in the originating network. At 920, the call may be received by an authentication/verification device. For example, the authentication/verification device may be configured to carry out one or more STIR/SHAKEN functionalities. For example, the authentication/verification device may comprise a STIR/SHAKEN server. For example, the switch may forward the call to the authentication/verification device. At 930, the authentication/verification device may determine whether or not there is an RCD profile associated with a user associated with the originating user device. For example, an RCD profile may comprise various details to be signed as part of the RCD process. The RCD profile may contain all the claims data (e.g., logo, logo url, display name, call reason, and other additional supplemental data). For example, each originating phone number may be associated with one or more RCD profiles. For example, this determination may be made based on one or more identifiers associated with the originating user device. If it is determined that there is an RCD profile associated with the user associated with the originating user device, at 940, the authentication/verification device may fetch the RCD profile in order to sign the call. At 950, the call may be signed and encoded. For example, the call may be signed and encoded with basic claims and/or RCD claims. For example, basic claims may comprise originating telephone number, destination telephone number, time, etc. At 960, the authentication/verification device and/or an RCD display processor may repackage (e.g., replace) one or more display name fields (e.g., repopulate the one or more display name fields) with RCD information. Further, and optionally at 960, one or more validation/verification statuses may be determined and/or one or more validation/verification indicators may be inserted into the call. If it is determined that there is no RCD profile associated with the user associated with the originating user device, at 970, the call may be signed and encoded with basic claims. At 980, the call may be sent back to the switch with the repackaged RCD for forwarding out to the transit network. At 990, the process may end.

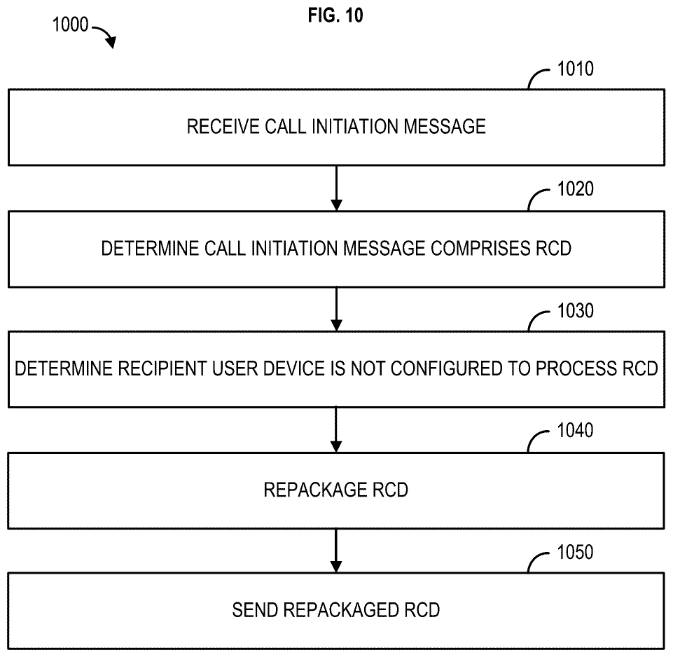

FIG. 10 shows an example method 1000. The method 1000 may be carried out on any one or more of the devices described herein. At step 1010, a call initiation message may be received. For example, the call initiation message may be received by a computing device. For example, the first computing device may comprise an authentication/verification device. The computing device may comprise, for example, an authentication/verification device. The authentication/verification device may be configured to process the RCD. For example, the authentication/verification device may be configured to execute one or more aspects of a STIR/SHAKEN (Secure Telephone Identity Revisited/Signature-based Handling of Asserted information using toKENs) protocol. For example, the authentication/verification device may comprise a STIR/SHAKEN server. The STIR/SHAKEN server may be configured for storing and executing a suite of protocols and procedures intended to combat caller ID spoofing on public telephone networks. For example, STIR is defined as a series of RFC standards documents by a Working Group of the Internet Engineering Task Force. It works by adding a digital certificate to the Session Initiation Protocol information used to initiate and route calls in VoIP systems. The first public connection on the system, typically the VoIP service provider, examines the caller ID and compares it to a known list of IDs they provide to that customer. The provider then attaches an encrypted certificate to the SIP header with the service provider's identity and a trust value. VoIP software on the receiving end can check the authenticity of the message by decrypting STIR using the provider's public key. For example, SHAKEN is a suite of guidelines for public switched telephone networks that indicate how to deal with calls that have incorrect or missing STIR information. This may be in the form of additional information in the CNAM information of caller ID indicating the number has been spoofed.

The call initiation message may be sent by a sending user device (e.g., a first user device) and/or one or more intermediary devices that are part of an originating network, a transit network, or a terminating network.

The call initiation message may comprise one or more user identifiers. The one or more user device identifiers may be associated with a recipient user device. For example, the one or more user device identifiers associated with the recipient user device may comprise, for example, one or more IMSIs (International Mobile Subscriber Identities) one or more IMEIs (International Mobile Equipment Identities), one or more MAC (Media Access Control) addresses, one or more IP (Internet Protocol) addresses, one or more MIEDs (Mobile Equipment Identifiers), one or more ESNs (Electronic Serial Numbers), one or more ICCID (Integrated Circuit Card Identifiers) combinations thereof, or the like. The call initiation message may comprise one or more user device identifiers (as described above) associated with the initiating user device.

At 1020, it may be determined that the call initiation message comprises rich call data (RCD). The rich call data may be encoded into the outgoing call. The rich call data may be inserted into the outgoing call and configured to be output on the recipient device. The rich call data may be inserted into the outgoing call before the outgoing call leaves an originating network before entering the recipient network. Similarly, the rich call data may be inserted at the terminating network. The rich call data may be inserted, for example, into one or more fields of a session initiation protocol (SIP) invite. For example, the rich call data may comprise image data (e.g., a logo), text data (e.g., a message configured to be displayed via the recipient device), audio data, one or more resource identifiers (e.g., one or more URLs, or the like), combinations thereof, and the like.

At 1030, it may be determined that the recipient user device is not configured to process the RCD. For example, it may be determined that the recipient user device is not configured to process the supplemental data based on the one or more identifiers associated with the second user device. For example, one or more devices at the terminating network may determine, based on the one or more identifiers associated with the second user device, that the second user device is not configured to process the supplemental data. For example, a database of devices in the terminating network may be queried based on the one or more user device identifiers associated with the second user device.

At 1040, the RCD may be repackaged. Repackaging the RCD data may comprise repackaging the RCD to another protocol (e.g., SIP protocol), reading one or more RCD claims (e.g., CNAP (Caller Name Presentation) data, CNAM (Caller Name Delivery) data, one or more CRN/call reasons, one or more logos or other image data, one or more origination or destination headers, one or more identity headers, one or more display name headers, one or more URLs), decoding and/or decrypting the one or more RCD claims, converting to text, and populating the RCD data to a display name field. Repackaging the RCD data may comprise converting RCD data to SIP configurable data.

At 1050, the repackaged RCD data may be sent to the recipient user device. Sending the repackaged RCD data may comprise sending a SIP protocol communication.

The method may comprise causing the recipient user device to output the repackaged RCD data. For example, causing the recipient user device to output the repackaged RCD data may comprise causing the user device to convert the repackaged RCD data to audio data and outputting the audio data. The method may comprise determining, based on the one or more user device identifiers, a verification status associated with the recipient user device.

The method may comprise sending, to a user device, by a computing device, based on a determination that the user device is not configured to process rich call data (RCD), repackaged RCD. The method may comprise causing the user device to output the repackaged RCD. The method may comprise updating, based on a session renegotiation, the repackaged RCD data. The method may comprise sending, to the user device, the updated repackaged RCD data.

The method may comprise receiving, by a first computing device from a second computing device, based on a determination that a user device is not configured to process rich call data (RCD), the RCD. The method may comprise converting the RCD to audio data. The method may comprise sending the audio data to the second computing device.

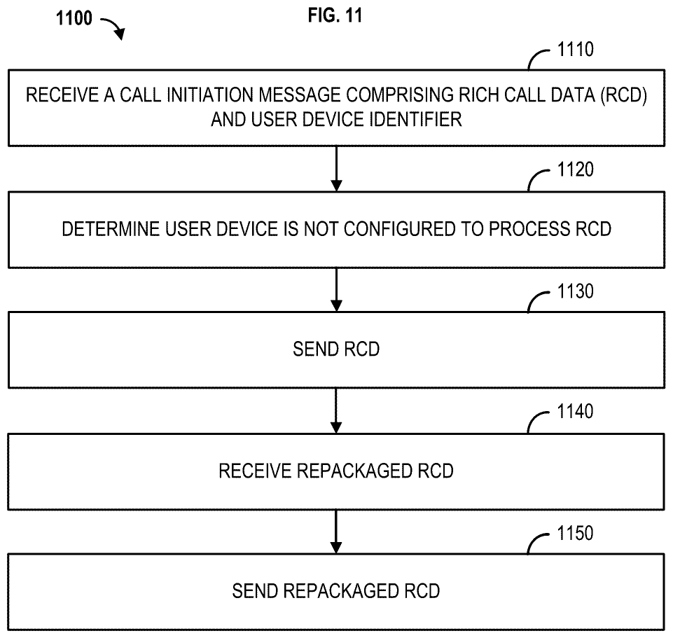

FIG. 11 shows an example method 1100. The method 1100 may be carried out via any one or more of the devices described herein. At 1110, a call initiation message may be received. For example, the call initiation message may be received by a first computing device. For example, the first computing device may comprise a switch device. The call initiation message may be sent by a sending user device (e.g., a first user device) and/or one or more intermediary devices that are part of an originating network, a transit network, or a terminating network.

The call initiation message may comprise one or more user identifiers. The one or more user device identifiers may be associated with a recipient user device. For example, the one or more user device identifiers associated with the recipient user device may comprise, for example, one or more IMSIs (International Mobile Subscriber Identities) one or more IMEIs (International Mobile Equipment Identities), one or more MAC (Media Access Control) addresses, one or more IP (Internet Protocol) addresses, one or more MIEDs (Mobile Equipment Identifiers), one or more ESNs (Electronic Serial Numbers), one or more ICCID (Integrated Circuit Card Identifiers) combinations thereof, or the like. The call initiation message may comprise one or more user device identifiers (as described above) associated with the initiating user device.

The call initiation message may comprise rich call data (RCD). The rich call data may be encoded into the outgoing call. The rich call data may be inserted into the outgoing call and configured to be output on the recipient device. The rich call data may be inserted into the outgoing call before the outgoing call leaves an originating network before entering the recipient network. Similarly, the rich call data may be inserted at the terminating network. The rich call data may be inserted, for example, into one or more fields of a session initiation protocol (SIP) invite. For example, the rich call data may comprise image data (e.g., a logo), text data (e.g., a message configured to be displayed via the recipient device), audio data, one or more resource identifiers (e.g., one or more URLs, or the like), combinations thereof, and the like.

At 1120, it may be determined that the recipient user device is not configured to process the RCD. For example, it may be determined that the recipient user device is not configured to process the supplemental data based on the one or more identifiers associated with the second user device. For example, one or more devices at the terminating network may determine, based on the one or more identifiers associated with the second user device, that the second user device is not configured to process the supplemental data. For example, a database of devices in the terminating network may be queried based on the one or more user device identifiers associated with the second user device.

At 1130, the RCD may be sent to a second computing device. The second computing device may comprise, for example, an authentication/verification device. The authentication/verification device may be configured to process the RCD. For example, the authentication/verification device may be configured to execute one or more aspects of a STIR/SHAKEN (Secure Telephone Identity Revisited/Signature-based Handling of Asserted information using toKENs) protocol. For example, the authentication/verification device may comprise a STIR/SHAKEN server. The STIR/SHAKEN server may be configured for storing and executing a suite of protocols and procedures intended to combat caller ID spoofing on public telephone networks. For example, STIR is defined as a series of RFC standards documents by a Working Group of the Internet Engineering Task Force. It works by adding a digital certificate to the Session Initiation Protocol information used to initiate and route calls in VoIP systems. The first public connection on the system, typically the VoIP service provider, examines the caller ID and compares it to a known list of IDs they provide to that customer. The provider then attaches an encrypted certificate to the SIP header with the service provider's identity and a trust value. VoIP software on the receiving end can check the authenticity of the message by decrypting STIR using the provider's public key. For example, SHAKEN is a suite of guidelines for public switched telephone networks that indicate how to deal with calls that have incorrect or missing STIR information. This may be in the form of additional information in the CNAM information of caller ID indicating the number has been spoofed.

The second computing device may configured to repackage the RCD. Repackaging the RCD data may comprise repackaging the RCD to another protocol (e.g., SIP protocol), reading one or more RCD claims (e.g., CNAP (Caller Name Presentation) data, CNAM (Caller Name Delivery) data, one or more CRN/call reasons, one or more logos or other image data, one or more origination or destination headers, one or more identity headers, one or more display name headers, one or more URLs), decoding and/or decrypting the one or more RCD claims, converting to text, and populating the RCD data to a display name field. Repackaging the RCD data may comprise converting RCD data to SIP configurable data.

At 1140, repackaged RCD may be received. For example, the repackaged RCD may be received by the first computing device from the second computing device.

At 1150, the repackaged RCD may be sent to the recipient user device.

The method may comprise causing the recipient user device to output the repackaged RCD data. For example, causing the recipient user device to output the repackaged RCD data may comprise causing the user device to convert the repackaged RCD data to audio data and outputting the audio data. The method may comprise determining, based on the one or more user device identifiers, a verification status associated with the recipient user device.

The method may comprise sending, to a user device, by a computing device, based on a determination that the user device is not configured to process rich call data (RCD), repackaged RCD. The method may comprise updating, based on a session renegotiation, the repackaged RCD data. The method may comprise sending, to the user device, the updated repackaged RCD data.

The method may comprise receiving, by a first computing device from a second computing device, based on a determination that a user device is not configured to process rich call data (RCD), the RCD. The method may comprise converting the RCD to audio data.

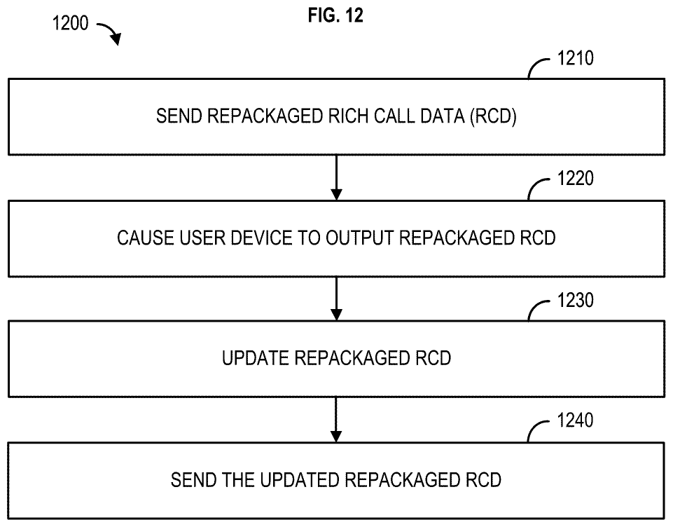

FIG. 12 shows an example method 1200. The method 1200 may be carried out via any one or more of the devices described herein. At 1210, repackaged rich call data (RCD) may be sent. For example, the repackaged RCD may be sent to a user device (e.g., a recipient user device, a second user device). For example, the repackaged RCD may be sent by a computing device. For example, the computing device may comprise a switch device. For example, the repackaged RCD may be sent to the user device based on a determination that the user device is not configured to process RCD. Repackaging the RCD data may comprise reading one or more RCD claims (e.g., CNAP (Caller Name Presentation) data, CNAM (Caller Name Delivery) data, one or more CRN/call reasons, one or more logos or other image data, one or more origination or destination headers, one or more identity headers, one or more display name headers, one or more URLs), decoding and/or decrypting the one or more RCD claims, converting to text, and populating the RCD data to a display name field. Repackaging the RCD data may comprise converting RCD data to SIP configurable data.

At 1220, the user device may be caused to output the repackaged RCD data. Outputting the repackaged RCD data may comprise causing the user device to output audio data, image data, text data, haptic data, combinations thereof, and or the like. The repackaged RCD may comprise one or more advertisements, one or more logos, combinations thereof, and the like.

At 1230, the repackaged RCD may be updated. For example, the repackaged RCD may be updated based on a session renegotiation. A session renegotiation may comprise carrying out a (new, second, subsequent) handshake process over an existing connection (e.g., an SSL connection).

At 1240, the updated repackaged RCD may be sent to the user device. The updated repackaged RCD may comprise, for example, content. For example, the content may comprise one or more advertisements. The updated repackaged RCD may comprise, for example, audio data.

The method may comprise causing the user device to output the updated repackaged RCD. For example, causing the user device to output the updated repackaged RCD may comprise causing the user device to convert the updated repackaged RCD to audio data, image data, text data, haptic data, combinations thereof, and the like and causing the user device to output the audio data, image data, text data, haptic data, combinations thereof, and the like.

The method may comprise receiving, by a first computing device, a call initiation message comprising rich call data (RCD) and one or more user device identifiers associated with a user device. The method may comprise determining, based on the user device identifier, the user device is not configured to process the RCD. The method may comprise sending, to a second computing device, the RCD. The method may comprise receiving, from the second computing device, repackaged RCD. The method may comprise sending, to the user device, the repackaged RCD.

The method may comprise receiving, by a first computing device from a second computing device, based on a determination that a user device is not configured to process rich call data (RCD), the RCD. The method may comprise converting the RCD to audio data. The method may comprise sending the audio data to the second computing device.

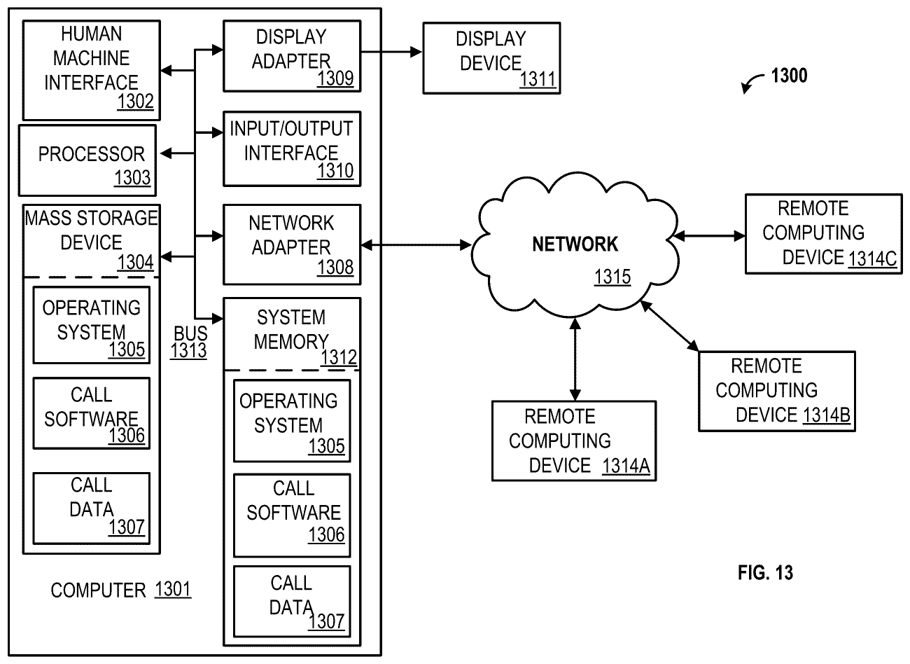

FIG. 13 shows a system 1300 for communication management. The computer 1301 may comprise one or more processors 1303, a system memory 1312, and a bus 1313 that couples various system components including the one or more processors 1303 to the system memory 1312. In the case of multiple processors 1303, the computer 1301 may utilize parallel computing. The bus 1313 is one or more of several possible types of bus structures, including a memory bus or memory controller, a peripheral bus, an accelerated graphics port, or local bus using any of a variety of bus architectures.

The computer 1301 may operate on and/or comprise a variety of computer readable media (e.g., non-transitory). The readable media may be any available media that is accessible by the computer 1301 and may comprise both volatile and non-volatile media, removable and non-removable media. The system memory 1312 has computer readable media in the form of volatile memory, such as random access memory (RAM), and/or non-volatile memory, such as read only memory (ROM). The system memory 1312 may store data such as the call data 1307 and/or program modules such as the operating system 1305 and the call software 1306 that are accessible to and/or are operated on by the one or more processors 1303. The machine learning module may comprise one or more of the call data 1307 and/or the call software 1306.

The computer 1301 may also comprise other removable/non-removable, volatile/non-volatile computer storage media. FIG. 13 shows the mass storage device 1304 which may facilitate non-volatile storage of computer code, computer readable instructions, data structures, program modules, and other data for the computer 1301. The mass storage device 1304 may be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any quantity of program modules may be stored on the mass storage device 1304, such as the operating system 1305 and the call software 1306. Each of the operating system 1305 and the call software 1306 (or some combination thereof) may comprise elements of the program modules and the call software 1306. The call data 1307 may also be stored on the mass storage device 1304. The call data 1307 may be stored in any of one or more databases known in the art. Such databases may be DB2®, Microsoft® Access, Microsoft® SQL Server, Oracle®, MySQL, PostgreSQL, and the like. The databases may be centralized or distributed across locations within the network 1315.

A user may enter commands and information into the computer 1301 via an input device (not shown). Examples of such input devices comprise, but are not limited to, a keyboard, pointing device (e.g., a computer mouse, remote control), a microphone, a joystick, a scanner, tactile input devices such as gloves, and other body coverings, motion sensor, and the like These and other input devices may be connected to the one or more processors 1303 via a human machine interface 1302 that is coupled to the bus 1313, but may be connected by other interface and bus structures, such as a parallel port, game port, an IEEE 1394 Port (also known as a Firewire port), a serial port, network adapter 1308, and/or a universal serial bus (USB).

The display device 1311 may also be connected to the bus 1313 via an interface, such as the display adapter 1309. It is contemplated that the computer 1301 may comprise more than one display adapter 1309 and the computer 1301 may comprise more than one display device 1311. The display device 1311 may be a monitor, an LCD (Liquid Crystal Display), light emitting diode (LED) display, television, smart lens, smart glass, and/or a projector. In addition to the display device 1311, other output peripheral devices may be components such as speakers (not shown) and a printer (not shown) which may be connected to the computer 1301 via the Input/Output Interface 1310. Any step and/or result of the methods may be output (or caused to be output) in any form to an output device. Such output may be any form of visual representation, including, but not limited to, textual, graphical, animation, audio, tactile, and the like. The display device 1311 and computer 1301 may be part of one device, or separate devices.

The computer 1301 may operate in a networked environment using logical connections to one or more remote computing devices 1314A,B,C. A remote computing device may be a personal computer, computing station (e.g., workstation), portable computer (e.g., laptop, mobile phone, tablet device), smart device (e.g., smartphone, smart watch, activity tracker, smart apparel, smart accessory), security and/or monitoring device, a server, a router, a network computer, a peer device, edge device, and so on. Logical connections between the computer 1301 and a remote computing device 1314A, B, C may be made via 1315 network 1315, such as a local area network (LAN) and/or a general wide area network (WAN). Such network connections may be through the network adapter 1308. The network adapter 1308 may be implemented in both wired and wireless environments. Such networking environments are conventional and commonplace in dwellings, offices, enterprise-wide computer networks, intranets, and the Internet.

Application programs and other executable program components such as the operating system 1305 are shown herein as discrete blocks, although it is recognized that such programs and components reside at various times in different storage components of the computing device 1301, and are executed by the one or more processors 1303 of the computer. An implementation of the call software 1306 may be stored on or sent across some form of computer readable media. Any of the described methods may be performed by processor-executable instructions embodied on computer readable media.

While specific configurations have been described, it is not intended that the scope be limited to the particular configurations set forth, as the configurations herein are intended in all respects to be possible configurations rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the quantity or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

What is claimed is:

1. A method comprising:
receiving, by a computing device, a call initiation message;
determining the call initiation message comprises rich call data (RCD);
determining a recipient user device is not configured to process the RCD;
repackaging the RCD; and
sending the repackaged RCD to the recipient user device.

2. The method of claim 1, wherein the computing device comprises one or more of: a switch device, a STIR/SHAKEN device, or an RCD device.

3. The method of claim 1, wherein determining the recipient user device is not configured to process the RCD comprises determining one or more user device identifiers associated with the recipient user device.

4. The method of claim 1, wherein repackaging the RCD comprises converting one or more RCD claims to a display name in an SIP invite.

5. The method of claim 1, wherein repackaging the RCD comprises determining one or more packet headers.

6. The method of claim 1, wherein repackaging the RCD comprises determining one or more display attributes associated with the recipient user device.

7. The method of claim 1, further comprising causing the recipient user device to output the repackaged RCD.

8. The method of claim 1, further comprising converting one or more RCD claims to audio data.

9. The method of claim 1, further comprising sending the RCD to a database.

10. A method comprising:
receiving, by a first computing device, a call initiation message comprising rich call data (RCD) and one or more user device identifiers associated with a user device;
determining, based on the one or more user device identifiers, the user device is not configured to process the RCD;
sending, to a second computing device, the RCD;
receiving, from the second computing device, repackaged RCD; and
sending, to the user device, the repackaged RCD.

11. The method of claim 10, wherein the first computing device comprises a switch and wherein the second computing device comprises a STIR/SHAKEN server.

12. The method of claim 10, wherein the user device is configured to process session initiation protocol (SIP) invites.

13. The method of claim 10, wherein the repackaged RCD comprises one or more display names associated with the RCD.

14. The method of claim 10, wherein determining the user device is not configured to process the RCD comprises determining one or more output capabilities associated with the user device.

15. The method of claim 10, further comprising causing the user device to output the repackaged RCD.

16. The method of claim 15, wherein causing the user device to output the repackaged RCD comprises:
causing the user device to convert the repackaged RCD into audio data; and
causing the user device to output the audio data.

17. The method of claim 10, further comprising determining, based on the one or more user device identifiers, a verification status associated with the user device.

18. A method comprising:
sending, to a user device, by a computing device, based on a determination that the user device is not configured to process rich call data (RCD), repackaged RCD;
causing the user device to output the repackaged RCD;
updating, based on a session renegotiation, the repackaged RCD data; and
sending, to the user device, the updated repackaged RCD data.

19. The method of claim 18, wherein the computing device comprises a switch.

20. The method of claim 18, wherein the user device comprises a device configured to process session initiation protocol (SIP) data.

21. The method of claim 18, wherein the RCD comprises one or more user identifiers.

22. The method of claim 18, wherein the RCD comprises one or more claims and wherein the computing device is configured to determine the repackaged RCD by parsing the one or more claims.

23. The method of claim 18, wherein the computing device is configured to determine the repackaged RCD by parsing one or more packet headers associated with a call initiation message.

24. The method of claim 18, wherein the updated repackaged RCD data comprises one or more advertisements.

25. The method of claim 18, further comprising causing the user device to output the updated repackaged RCD.

26. The method of claim 25, wherein causing the user device to output the updated repackaged RCD comprises:
causing the user device to convert the updated repackaged RCD to audio data; and
causing the user device to output the audio data.
